(19) United States
(12) Patent Application Publication
(10) Pub. No.: US 2021/0025553 A1
(43) Pub. Date: Jan. 28, 2021

(54) Track Lighting and Accessory System

(71) Applicant: Electrix, LLC, New Haven, CT (US)

(72) Inventors: Ryan A. Frederick, Milford, CT (US); Mark E. Lahner, Guilford, CT (US)

(73) Assignee: Electrix, LLC, New Haven, CT (US)

(21) Appl. No.: 16/769,014

(22) PCT Filed: Dec. 4, 2018
(86) PCT No.: PCT/US18/63749

§ 371 Date: Jun. 2, 2020

Related U.S. Application Data
(60) Provisional application No. 62/640,890, filed on Mar. 9, 2018.

(51) Int. Cl. F21S 2/00; F21V 21/096; F21V 21/088; F21V 21/02; F21V 21/35

(52) U.S. Cl. CPC F21S 2/005; F21V 21/096; F21V 21/35; F21V 21/025; F21V 21/088

(57) ABSTRACT

A track lighting and accessory system comprises a body having a first sidewall and a second sidewall, a first channel formed in an inner surface of the first sidewall and a second channel formed in an inner surface of the second sidewall. One or more members are positioned with a first edge portion in the first channel and a second edge portion in the second channel. One or more biasing members are in the second channel engaging the one or more members and biasing the one or more members into the first channel.

### CROSS-REFERENCE TO RELATED APPLICATIONS

Benefit is claimed of U.S. Patent Application No. 62/594,228, filed Dec. 4, 2017, and entitled “Track Lighting and Accessory System” and U.S. Patent Application No. 62/640,890, filed Mar. 9, 2018, and entitled “Track Lighting and Accessory System”, the disclosures of which are incorporated by reference herein in their entireties as if set forth at length.

### BACKGROUND

The disclosure relates to track lighting. More particularly, the disclosure relates to board support in lighting tracks and device mounting.

Track lighting systems generally include a body which may be configured for flush mount, surface mount, or pendant situations. The body contains means for mounting individual light sources and means for electrically powering those light sources. These means may be continuous or a discrete array of features. Several recent proposals are seen in U.S. Pat. No. 8,950,909 of Ramirez, entitled “Light Fixture with Concealed Wireway”, Feb. 10, 2015. The bodies may be formed as aluminum extrusions having a pair of sidewalls and a transverse web connecting the sidewalls. Drivers and electrical contact features may be mounted within the bodies. Accordingly, the bodies may be extruded with internal features for such mounting. External features may generally correspond to the particular installation situation (flush versus surface mount versus pendant).

### SUMMARY

One aspect of the disclosure involves a system comprising: a body having a first sidewall and a second sidewall, a first channel formed in an inner surface of the first sidewall and a second channel formed in an inner surface of the second sidewall. One or more members are positioned with a first edge portion in the first channel and a second edge portion in the second channel. One or more biasing members are in the second channel engaging the one or more members and biasing the one or more members into the first channel.

In one or more embodiments of any of the foregoing embodiments, the one or more biasing members comprise one or more wave springs.

In one or more embodiments of any of the foregoing embodiments, the one or more biasing members comprise one or more metallic springs.

In one or more embodiments of any of the foregoing embodiments, the one or more members have, adjacent the first edge portion, a recess or through-hole in a lower surface.

In one or more embodiments of any of the foregoing embodiments, the one or more members comprise one or more board assemblies.

In one or more embodiments of any of the foregoing embodiments, the one or more board assemblies each comprise a plurality of electrical contacts running longitudinally along a lower surface of the board assembly.

In one or more embodiments of any of the foregoing embodiments, the one or more board assemblies each comprise a steel portion.

In one or more embodiments of any of the foregoing embodiments, the steel portion is a substrate extending along at least 90% of a footprint of the member.

In one or more embodiments of any of the foregoing embodiments, the substrate has, adjacent the first edge portion, a plurality of protrusions along an upper surface.

In one or more embodiments of any of the foregoing embodiments, the one or more board assemblies each comprise a first connector at a first end and a second connector at a second end.

In one or more embodiments of any of the foregoing embodiments, the one or more board assemblies are a plurality of board assemblies electrically connected via one or more pairs of adjacent said first connectors and said second connectors.

In one or more embodiments of any of the foregoing embodiments, one or more accessories having at least one magnet magnetically mounting the accessory to the one or more members via magnetic interaction with the steel portion.

In one or more embodiments of any of the foregoing embodiments, the one or more board assemblies each comprise a plurality of electrical contacts running longitudinally along a lower surface of the board assembly; and the one or more accessories have electrical contacts contacting the one or more electrical contacts of the one or more board assemblies.

In one or more embodiments of any of the foregoing embodiments, the body comprises an extrusion.

In one or more embodiments of any of the foregoing embodiments, the body comprises a plurality of aluminum alloy extrusions mounted end-to-end.

In one or more embodiments of any of the foregoing embodiments, a method for assembling the system comprises: with the one or more biasing members in the second channel, shifting the one or more members so that their respective second edge portions align with an opening of the second channel; shifting the one or more members to shift their respective second end portions into the second channel while rotating the one or more members to align their first edge portions with the first channel and compressing the one or more biasing members; and shifting the one or more members to seat their first edge portions into the first channel while leaving their second edge portions in the second channel.

In one or more embodiments of any of the foregoing embodiments, the method further comprises inserting a base of an accessory into the body between the first sidewall and the second sidewall so as to engage the one or more members electrically and magnetically, the magnetic engagement effective to retain the accessory to the body.

In one or more embodiments of any of the foregoing embodiments, the method further comprises assembling the body from a plurality of body segments, the body segments being assembled end-to-end with inter-linking members captured by adjacent sections.

Another aspect of the disclosure involves a seismic clip for retaining a fixture to a track channel. The track channel has a pair of opposed sidewalls, each having an inwardly-open channel. The seismic clip comprises: a body having a first face and a second face and first and second opposite sides; first and second members movable between a retracted condition and an extended condition protruding from the first and second sides respectively; and a spring, biasing the first and second members from the retracted condition toward the extended condition.

In one or more embodiments of any of the foregoing embodiments, a release member has a portion exposed or protruding through the second face.

In one or more embodiments of any of the foregoing embodiments, the release member is mounted for reciprocal movement.

In one or more embodiments of any of the foregoing embodiments, the first and second members are mounted for pivotal movement relative to the body about respective pivot axes.

In one or more embodiments of any of the foregoing embodiments, respective first and second links couple the first and second members to the release member and each have a respective proximal pivot relative to the release member and a respective distal pivot respectively relative to the first member and the second member.

In one or more embodiments of any of the foregoing embodiments, the release member has a portion having: a first condition protruding from a proximal edge of the body with the first and second members retracted; and a second condition retracted relative to the first condition with the first and second members extended.

In one or more embodiments of any of the foregoing embodiments, a fixture has a base with a first such seismic clip at one end and a second such seismic clip at another end.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is an exploded view of a segment of a track lighting and accessory system.

FIG. 2 is an end view of a track extrusion of the system.

FIG. 3 is an end view of the segment in an assembled condition.

FIG. 4 is a longitudinal vertical sectional view of the segment taken along line 4-4 of FIG. 3.

FIG. 5 is a view of a board assembly of the system.

FIG. 6 is a top view of the board assembly.

FIG. 7 is a bottom view of the board assembly.

FIG. 8 is a side view of the board assembly.

FIG. 9 is an end view of the board assembly.

FIG. 10 is an end view of a board assembly in an intermediate stage of installation to a track.

FIG. 11 is a view of two board assemblies and a power driver shown in an installed condition with other structural components removed for purposes of illustration.

FIG. 12 is a view of the segment showing installed devices.

FIG. 13 is an end view of the segment during device installation.

FIG. 14 is a top view of a mounting base of a device.

FIG. 15 is a view of a device as a light fixture with seismic clips attached at opposite ends of the mounting base.

FIG. 16 is a first view of the seismic clip.

FIG. 17 is a second view of the seismic clip.

FIG. 18 is a first exploded view of the seismic clip.

FIG. 19 is a second exploded view of the seismic clip.

FIG. 20 is an x-ray face view of the seismic clip with pawls in an extended condition.

FIG. 21 is an x-ray face view of the seismic clip with pawls in a retracted condition.

FIG. 22 is an end view of the device mounting base fully seated in a channel with seismic clip pawls retracted.

FIG. 22A is an enlarged view of a pawl in FIG. 22.

FIG. 22B is an enlarged view of a fall engagement pin in FIG. 22.

FIG. 23 is an end view of the base in the channel, slightly unseated, with pawls extended to retain the base to the channel.

FIG. 23A is an enlarged view of the pawl in FIG. 23.

FIG. 23B is an enlarged view of the fall engagement pin in FIG. 23.

Like reference numbers and designations in the various drawings indicate like elements.

### DETAILED DESCRIPTION

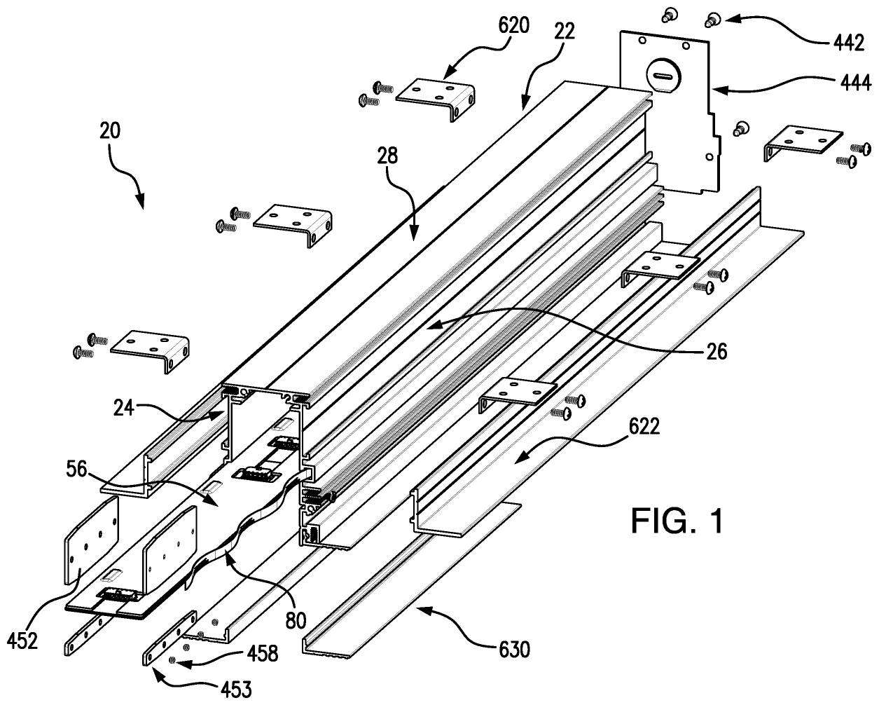

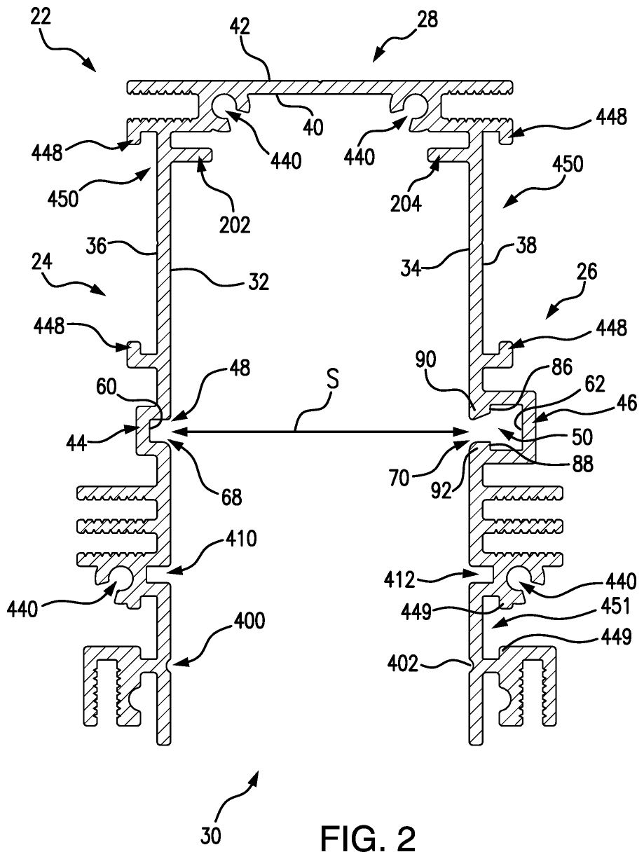

FIG. 1 is a partial, partially exploded, view of a track assembly in a low voltage lighting and accessory system. FIG. 1 shows one of a number of units 20 that may be assembled end-to-end. The resulting track assembly may itself extend from one end to another end or may be formed into a full loop structure via corner brackets. FIG. 2 shows a track extrusion 22 (e.g., aluminum alloy) having a first sidewall 24, a second sidewall 26, and a transverse web 28 joining the two sidewalls. The exemplary configuration places the web at one end of the cross-section of each sidewall leaving the opposite ends to form an opening 30. Alternative configurations may place the web 28 at a more intermediate location. The sidewalls have respective inner surfaces/faces 32, 34 and outer surfaces/faces 36, 38. Similarly, the web has two faces 40 and 42. The sidewall outer faces may bear mounting features appropriate to the mounting situation as is discussed above and further below.

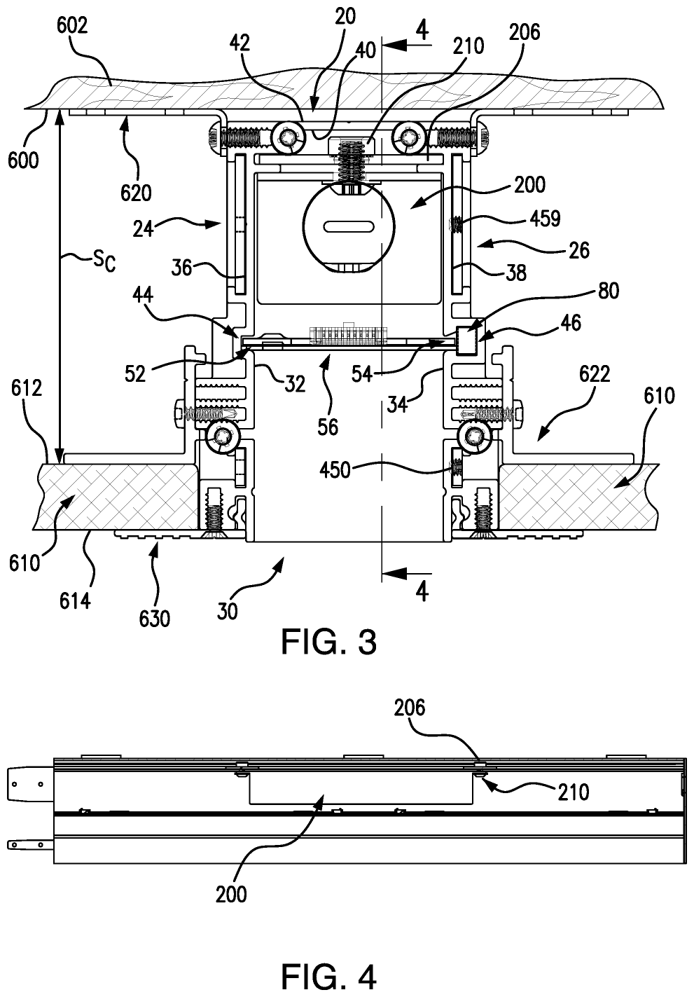

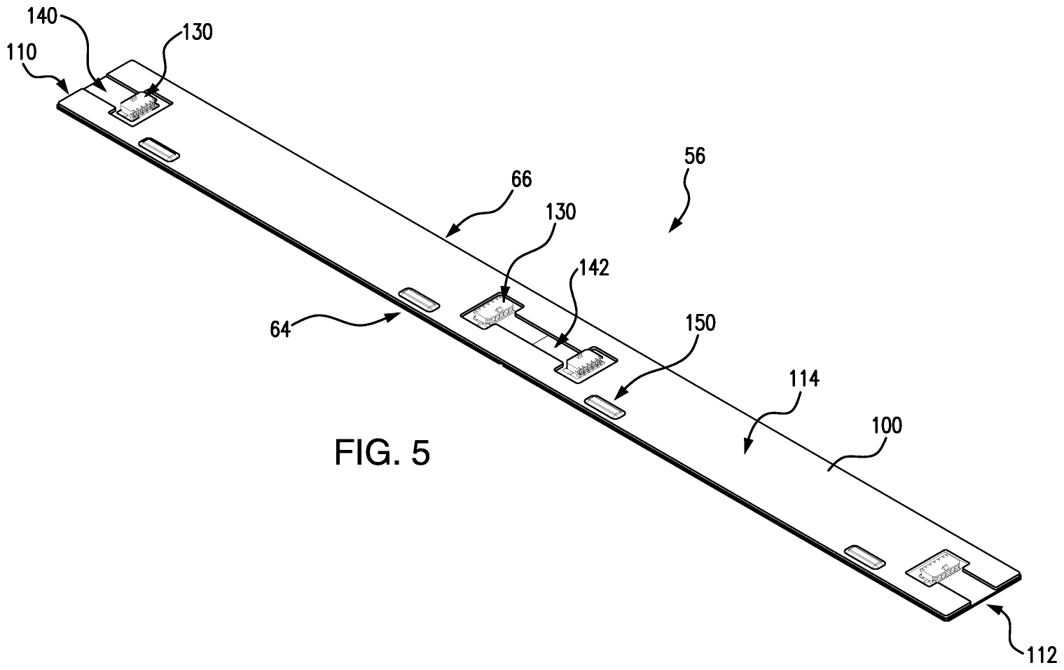

The exemplary configuration forms the sidewalls 24, 26 with opposed inwardly-open channel portions 44, 46 forming respective channels 48, 50 along the inner surfaces. In service, the channels accommodate respective edge portions 52, 54 (FIG. 3) of board assemblies (boards) 56. FIGS. 5-9 show further details of a board 56. As is discussed below, the boards may provide one or both of powering and mounting features/means for the individual light sources (or other accessories).

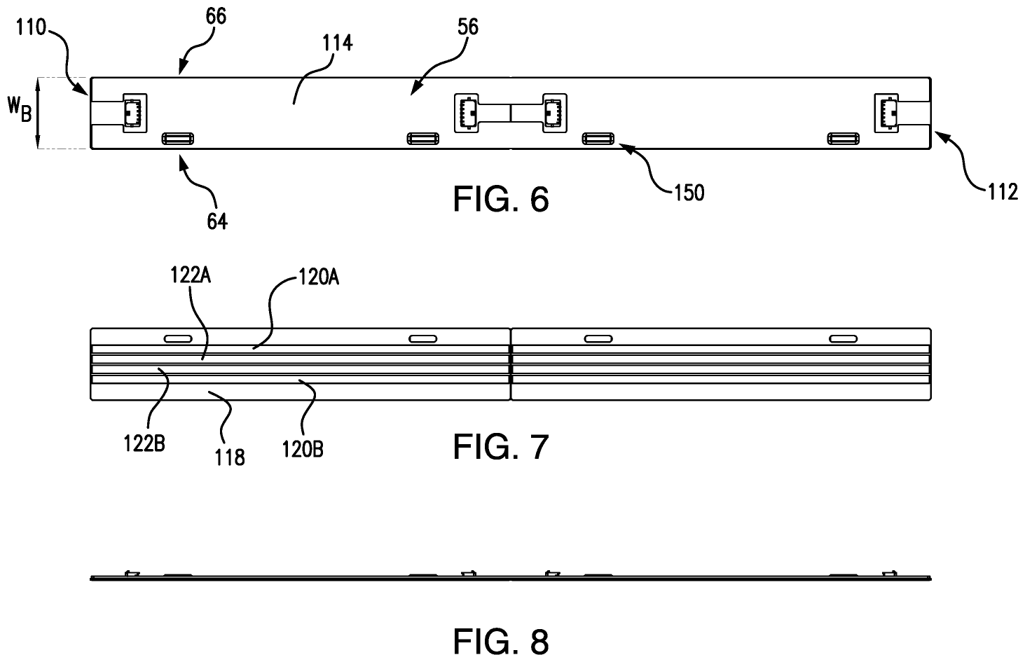

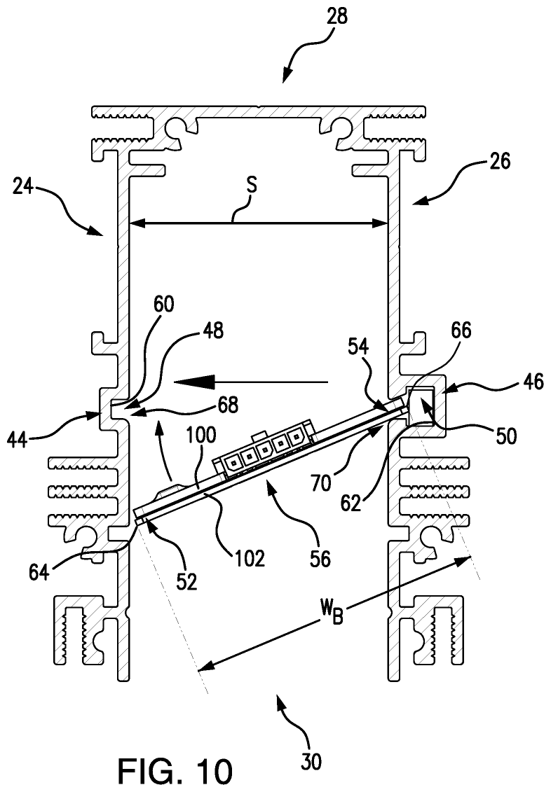

In the exemplary implementation, a spacing between bases 60, 62 (FIG. 2) of the channels 48, 50 is greater than a width WB of the board (FIG. 6—between edges 64, 66) but a spacing S between openings 68, 70 (FIG. 2) of the channels is less. In the particular implementation, the channels are asymmetric with the channel 50 of the second sidewall being deeper than the channel 48 of the first sidewall. The width WB of the board is greater than the sum of the spacing S between channel openings plus the depth of the first channel 48 but less than the sum of that spacing S plus the depth of the second channel 50. This allows the board 56 to be inserted through the opening 30 at an angle until the second edge 66 of the board is aligned with the opening 70 of the second channel 50. The board second edge portion 54 may be slid into the second channel 50 while rotating the first edge 64 upward (arcuate arrow in FIG. 10) until the first edge 64 is in alignment with the opening of the first channel. The board first edge portion 52 may then be slid (straight arrow in FIG. 10) into the first channel so that the board is retained by the two channels.

The exemplary embodiment places a resilient member 80 (FIG. 10—e.g., a spring such as a metallic wave spring) in the second channel 50 so that the board second edge 66 depresses the spring during insertion and the spring partially relaxes to shift the board first edge into the first channel 48. In this embodiment, therefore, the second channel 50 is shaped to have a slightly broader main portion than its opening so that the undersides 86, 88 of flanges 90, 92 (FIG. 2) at the opening capture one face of the spring 80 with the base 62 of the channel engaging the other face of the spring. The spring may be installed via longitudinal insertion and may be installed in segments.

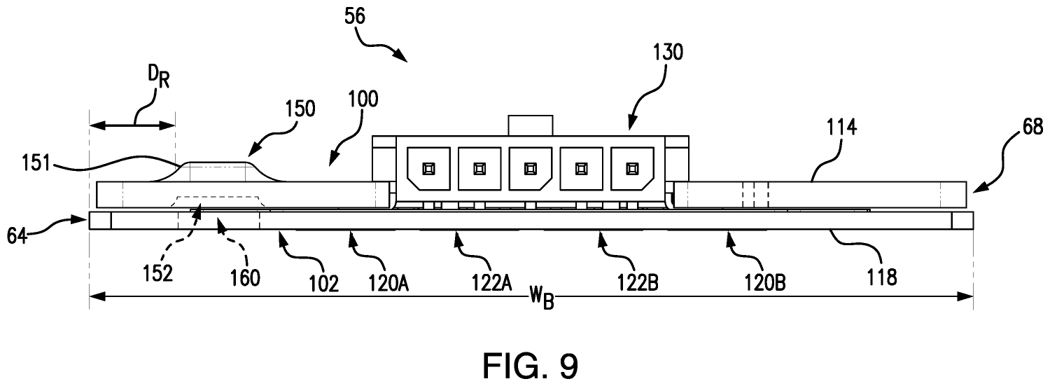

The exemplary board 56 (FIG. 9) comprises a combination of one or more metallic plates 100 and one or more printed circuit boards (PCB) 102. As is discussed further below, in the installed condition, the plate(s) 100 are atop the PCB(s) 102 and may be secured thereto via adhesive (e.g., epoxy). The plate 100 provides structural integrity and one half of a magnetic coupling for mounting lights or other accessories. The PCB 102 carries conductive traces/conductors on its underside 118 to act as contacts for power and/or control of the lights or other accessories. The exemplary configuration involves power conductors 120A, 120B (collectively or individually 120) (FIG. 7) and data conductors 122A, 122B (collectively or individually 122). The exemplary configuration assembles the board 56 out of one plate 100 and a pair of end-to-end PCBs 102. As is discussed below, this allows cutting of one of the boards 56 in half to accommodate a particular length of run. This saves installation time relative to having to assemble smaller boards for the entire length of the run. At the end of a run, a board 56 may be cut other than at the gap between PCBs. For example, the two-foot board could be cut to twenty inches to fit a twenty-inch space. This would leave a full PCB attached to the prior board and then eight inches of a final PCB in the run connected to the full PCB.

In alternative embodiments, both sets of conductors may be power conductors. For example, one set may be switched and another un-switched. Or, they may be two distinct voltages (e.g., 5V DC and 12V DC). With yet more conductors, more combinations may be made including control wiring and data collection.

The board 56 has ends 110, 112 (FIG. 5) and edges 64, 66. The upper surface of the board is generally formed by the upper or top surface 114 of the plate 100, while the lower surface (underside) of the board is generally formed by the respective lower surfaces (undersides) 118 (FIG. 9) of the PCBs. The plate 100 itself has respective ends adjacent the ends 110, 112 and edges adjacent the edges 64, 66. The PCBs similarly have ends and edges with, for a given pair of PCBs, one end of one PCB adjacent the other end of the other PCB at the center of the board 56.

The plates 100 have apertures for passing connectors 130 from the PCBs (FIG. 5—e.g., connectors mounted to upper surfaces of the PCBs). The exemplary configuration places one open terminal slot 140 (FIG. 5) at each end of the board 56/plate 100 accommodating one connector 130 and a longer central closed slot 142 accommodating two connectors at respective adjacent ends of the two associated boards. The connectors allow connection of boards to power and control and/or to each other in a daisy chain (via jumper wiring) or similar configuration.

The board 56 may be keyed to prevent mis-installation (e.g., to prevent the first edge portion 52 of the board from being successfully inserted in the second channel 50). In the exemplary embodiment, the board metallic plate 100 is embossed from below with tabs (stops) 150 protruding upward slightly recessed from board the first edge 64. The recessing depth D_{R}, for example, may be exactly the depth of the first channel or may be slightly smaller or greater. The relevant factor is that the depth is such that if the first edge 64 were inserted into the second channel, the tabs 150 would hit the second sidewall of the extrusion (e.g., at the flange 90) before enough of the board had gone in to the second channel 50 to enable the second 66 edge to be tilted up into alignment with the first channel 48. Thus, for example, the width of the board from the second edge to the first edge side 151 (FIG. 9) of the stop tabs 150 may be greater than the spacing S between channels adjacent their openings.

The illustrated asymmetry between flanges 90 and 92 (FIG. 2—the downwardly tapering portions of their respective lower and upper surfaces) minimizes the height between the lowest portion of 90 and the highest portion of 92 while still allowing the board edge insertion at an angle. This minimized height allows close accommodation when horizontal so as to limit any vertical play available for vibration/rattling.

FIG. 9 also shows through-holes 160 in the PCB 102 aligned with the tabs 150. In the exemplary implementation, the plate 100 is pre-embossed with the tabs before assembly to the PCBs 102 and the holes 160 are pre-cut in the PCBs. The holes 160 allow a user to insert a screwdriver into a hole 160 (or pair of screwdrivers into two different of the holes), with the tip(s) of the screwdriver(s) potentially firmly supported against the recess 152 in the underside of the tab). The user can then draw the PCB laterally to compress the spring 80 (FIG. 3) and bring the first edge portion 52 out of the first channel 48, allowing the PCB to be removed via downward rotation of its first edge in the opposite direction from the FIG. 10 installation. To make this yet easier, a special tool could be provided that can hook into the hole (e.g., capturing a portion of the upper surface of the PCB) to allow a downward pulling.

As noted above, the channel formed by the extrusion 22 may contain electronics such as a driver 200 (FIG. 3). FIG. 2 shows the extrusion formed with flanges 202 and 204 creating lateral slots thereabove. Plates 206 (FIG. 3) may be inserted from the ends of the extrusion with edge portions captured by those slots. The driver 200 or other components may then be fastened to such plates from below (such as via fasteners 210, e.g., screws and nuts). In one particular embodiment, the nuts are captive nuts mounted to the plates 206.

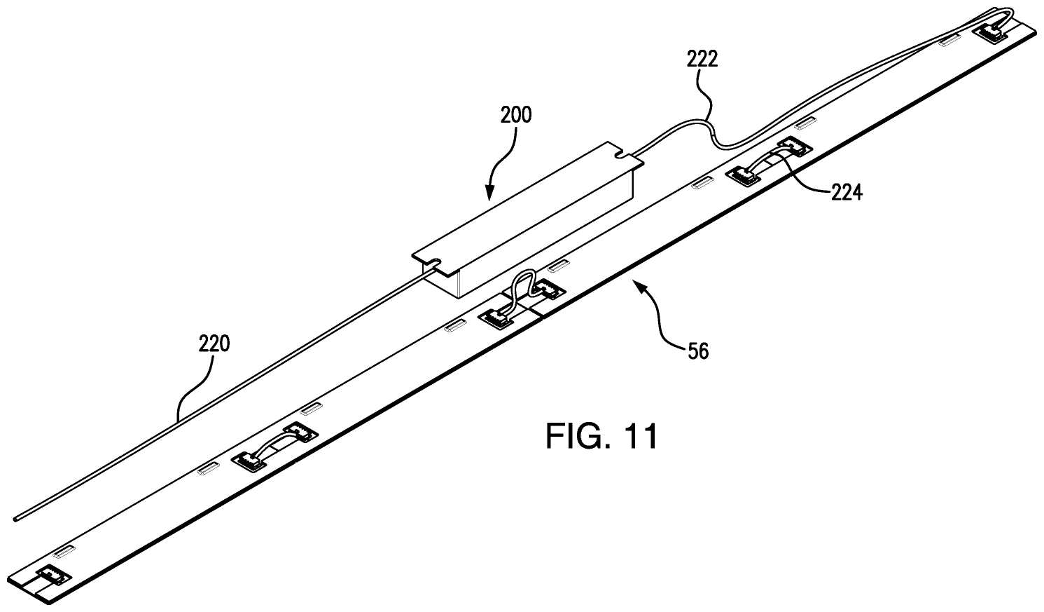

FIG. 11 shows a single driver 200 having a high voltage input feed cable 220 and a low voltage wiring harness 222 extending therefrom. The low voltage wiring harness may serve many boards 56 in parallel. FIG. 11 shows two assemblies 56 but the harness continues and may feed multiple additional boards. FIG. 11 also shows jumpers 224 between the adjacent connectors of the two PCBs of a given exemplary board 56. Low voltage communications may similarly be fed to the boards. However, further variation involves the low voltage conductors being used for communication between different accessories mounted to the boards (discussed below). Also, although not shown, one or more further connections (e.g., sockets on the housing of the driver 200 or branch connectors along the cable 220) may pass the high voltage power further downstream to other drivers.

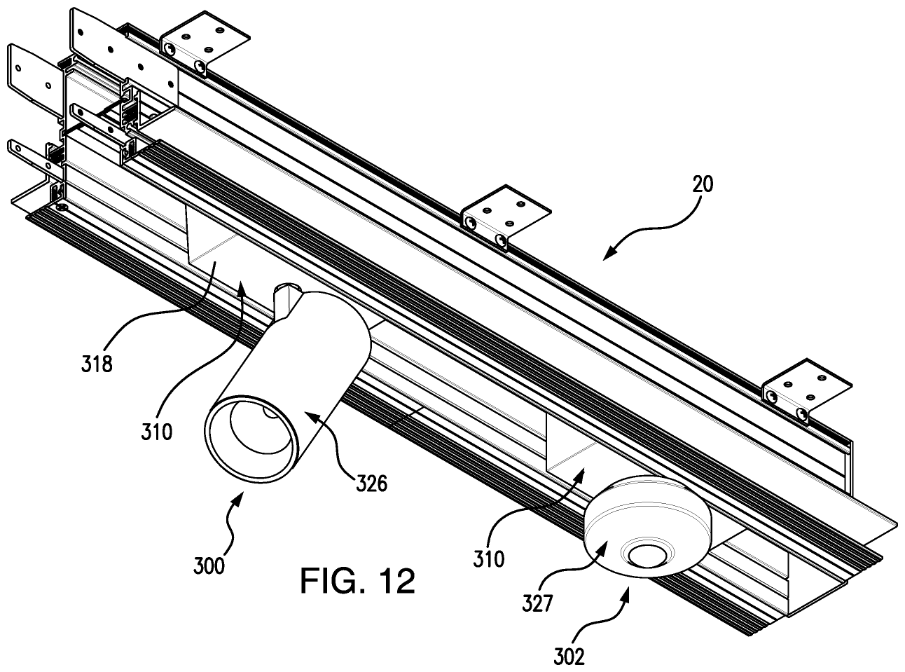

FIG. 12 shows an exemplary pair of items that could be mounted to the track in the form of a light fixture 300 (shown as a spot light) and a camera 302. Each of these lights or accessories (hereafter broadly devices) may have a base portion (mounting base) 310 mountable in the slot and may have some additional portion (light housing 326 and camera body 327) protruding below the track opening 30.

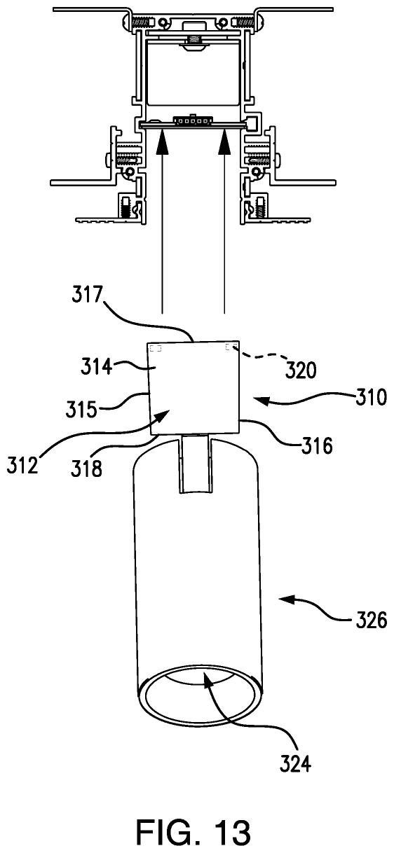

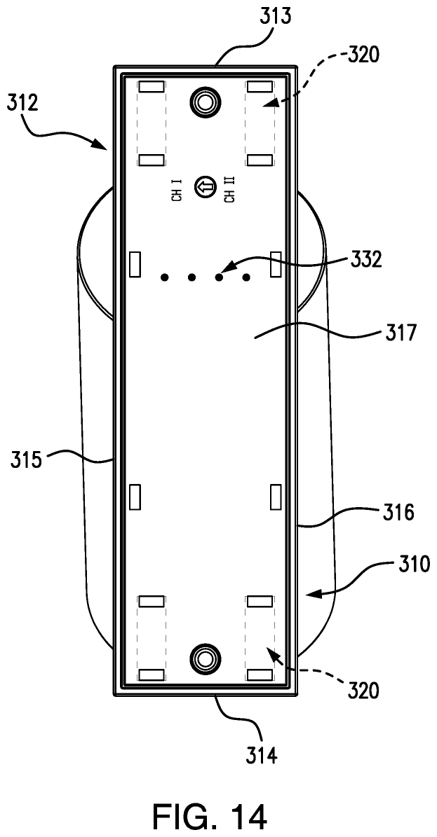

FIG. 13 shows the base 310 as containing magnets 320 which, with the base installed, magnetically engage the plate 100 to hold the base in place. FIG. 13 also shows the light source 324 (e.g., bulb(s) or LED(s) in a housing 326 reorientable relative to the base. The exemplary base is generally formed as a right parallelepiped having a body (e.g., assembled from molded plastic or machined or stamped metal) 312 with respective first and second ends 313, 314 (FIG. 14), first and second side surfaces 315, 316, an upper surface 317, and a lower surface 318 (FIG. 13).

FIG. 14 shows the upper surface 317 of the base 310 bearing power contacts 332 (e.g., spring-loaded “pogo” pins) and communications contacts (if any, not shown) for engaging the respective PCB conductors/contacts 120 and 122.

In one example of control via the conductors 122, one of the devices may be a light sensor which, in turn, sends control signals to all the lights or a group of lights to turn on or regulate their output.

FIG. 2 shows additional internal features of the exemplary track extrusions 22. Slightly above the opening 30, the two inner surfaces 32 and 34 bear shallow recesses 400, 402. These may serve to provide a detent-like engagement with a cover (not shown—e.g., molded plastic). For example, opaque covers may be installed in regions longitudinally between the device bases 310. Alternatively, some implementations may involve a light source of an LED strip which is recessed within the channel and the recesses 400 and 402 may accommodate a lens or diffuser.

FIG. 2 also shows deeper channels 410, 412. These may accommodate retention clips. For example, the base 310 may have spring-loaded clips (not shown) along its respective side faces with feet that can snap into the channels 410, 412 when the base is installed. The height of the channels 410, 412 allows the feet to have some play when the base 310 upper surface 317 is seated against the board 56 via their respective contacts so as to not interfere with the electrical contact. However, if there is vibration which may start to dislodge the base against its magnetic interaction, the clips will contact the lower sides of the channels 410, 412 and resist further downward movement. The resistance may be a sufficient detenting or may be a resistance that is not non-destructively overcome by extraction force but rather requires some form of actuation/release of the clip.

As noted above, myriad mounting features may be formed in the extrusion and may engage one or more of myriad additional components depending upon the implementation. FIG. 3 shows an exemplary ceiling or wall mounting situation such as to the underside 600 of a ceiling substrate (which could be framing 602 supporting a suspended wallboard structure 610). Thus, the configuration may provide an essentially flush appearance relative to the surface of the ceiling formed by the wallboard 610. FIG. 3 also shows the wallboard 610 as having an upper surface 612 and a lower surface 614. The exemplary situation contemplates a spacing S_{C} between the surface 600 and the surface 612 similar to that of dimensional lumber (e.g., 5.5 inches for a two-by-six, 3.5 inches for a two-by-four, or 2.5 inches for a two-by-three) so that the system may coexist with two-by-sixes, two-by-fours, or two-by-threes, respectively, supporting the wallboard at other locations. Thus, the exemplary implementation involves the extrusions having mounting features for engaging mounting brackets 620 to mount to the surface 600. It also includes features for engaging brackets 622 for supporting the upper surface of the adjacent wallboard on opposite sides of the track. The exemplary implementation also includes features for engaging mud flanges 630 for extending along the undersides 614 of the wallboard and allowing mud/plaster application to provide a smooth transition. Alternatively, the mud flanges could be replaced by trim pieces that are not later covered with mud/plaster. Alternative configurations (not shown) of the extrusion may be configured for a surface mount situation where the fixture is mostly proud of the surrounding surface of the wall or ceiling rather than flush. Yet other configurations (not shown) may be pendant configurations where the fixture is suspended below the adjacent ceiling level.

The exemplary extrusions include multiple features including partial open rounds 440 (FIG. 2) for receiving the shafts of screws 442 (FIG. 1) to attach endplates 444 and the like. The exemplary configuration further includes features 448, 449 forming the sides of channels 450, 451 for receiving plates 452, 453 (FIG. 1) or other members that link adjacent segments. These may be secured via set screws 458.

The system may be made using otherwise conventional or yet-developed materials and techniques. In an exemplary situation, the various components may be provided in various lengths based upon the ease of manufacture, transport, and use given their respective roles. For example, as noted above, the boards may be formed with an exemplary nominal length of two feet given standard United States building practices. A board 56 may, however, be cut in half such as at a score line pre-formed in the plate 100 adjacent the junction between PCBs 102. Thus, in a situation requiring an odd number of feet, an installer could simply install a number of complete boards 56 and then cut one board to provide the last needed foot. Other components may be longer. For example, the extrusions and the mud flanges or other trim pieces in lieu of mud flanges could be in eight foot lengths or, at least four foot lengths. On-site, an appropriate number of complete lengths could be assembled and then a cut piece used to make up any needed amount. The springs, similarly, could be in large lengths or, due to the relative ease of their installation, could be in shorter lengths such as one foot or two feet.

Thus, an exemplary on-site assembly sequence involves basic mechanical assembly of the tracks (using the extrusions and connector plates and, if any, end caps, corner pieces, and the like). Depending upon the situation, this may be done before dry wall or other installation of ceiling or wall material. An electrician may then install the drivers and wire them up to any external power and communications (or at least run wires for such power and communication). At this point, the open channels allow inspection. Furthermore, a technician (not necessarily the same technician because of distinction between the mechanical and electrical trades) may electrically connect the boards to each other and to the driver(s) and may leave them hanging for electrical inspection. Thereafter, the boards may be inserted and seated. At some point during this process (depending upon business and regulatory requirements) additional mechanical work may be done such as the mounting of wall board, mudding, and the like. Finally, the devices may be installed and additional trim (such as covers for inter-device gaps) installed.

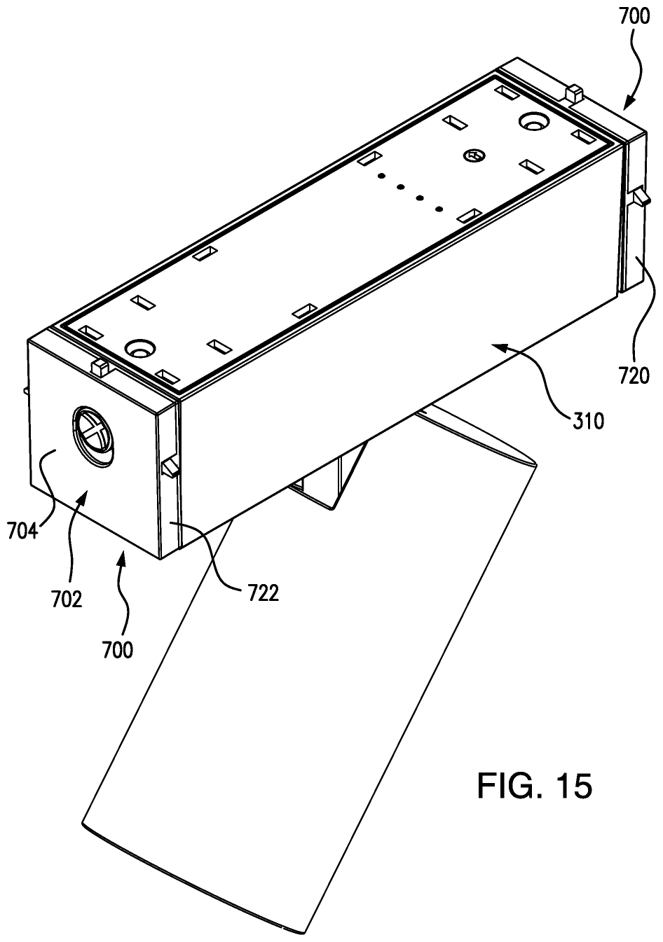

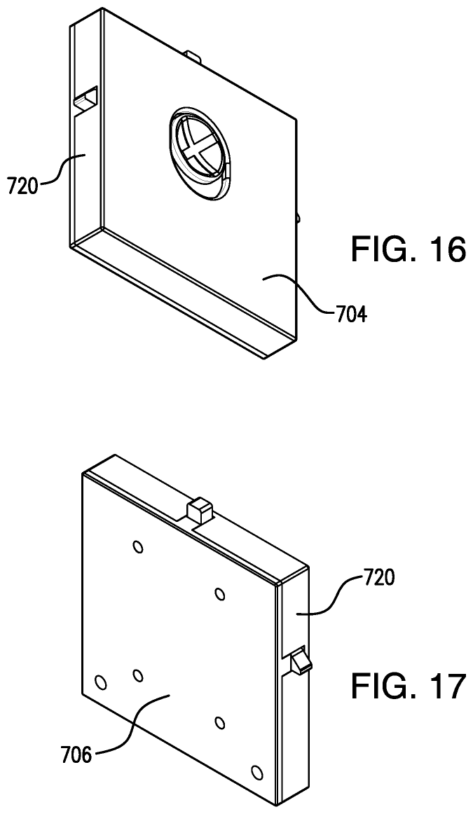

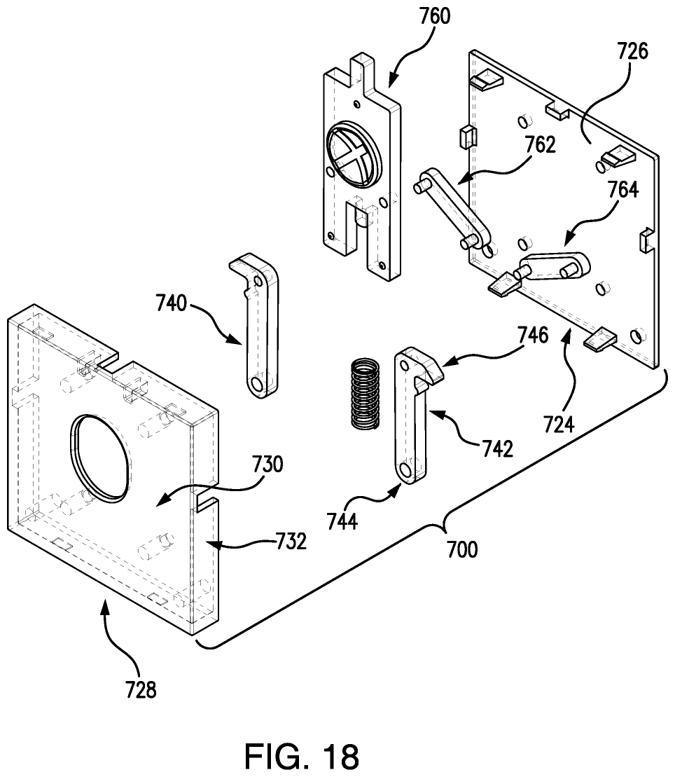

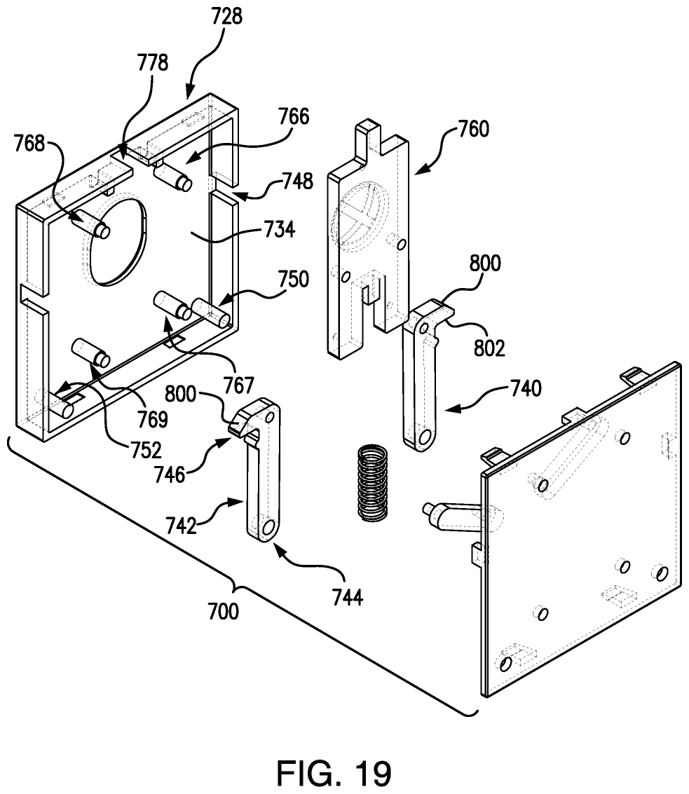

FIG. 15 shows a further variation of a light fixture wherein, at opposite ends 313, 314, the mounting base 310 has seismic clips 700 mounted thereto. Each exemplary seismic clip has a body 702 having a first face 704 (facing outward from the fixture base) and a second face 706 (FIG. 17, e.g., facing and abutting an associated end of the mounting base). Each clip has a respective first side 720 and second side 722. In the exemplary embodiment, with identical clips, the first side of the clip at one end of the base is at the same side of the base as the second side of the clip at the other end. The exemplary body 702 construction comprises a base plate 724 (FIG. 18) with one face forming the second surface 706 and another face 726 facing inward within the clip. The body further comprises a cover member 728 having a plate portion 730 and a perimeter sidewall 732. The plate portion has a face forming the first face 704 and a face 734 (FIG. 19) facing inward.

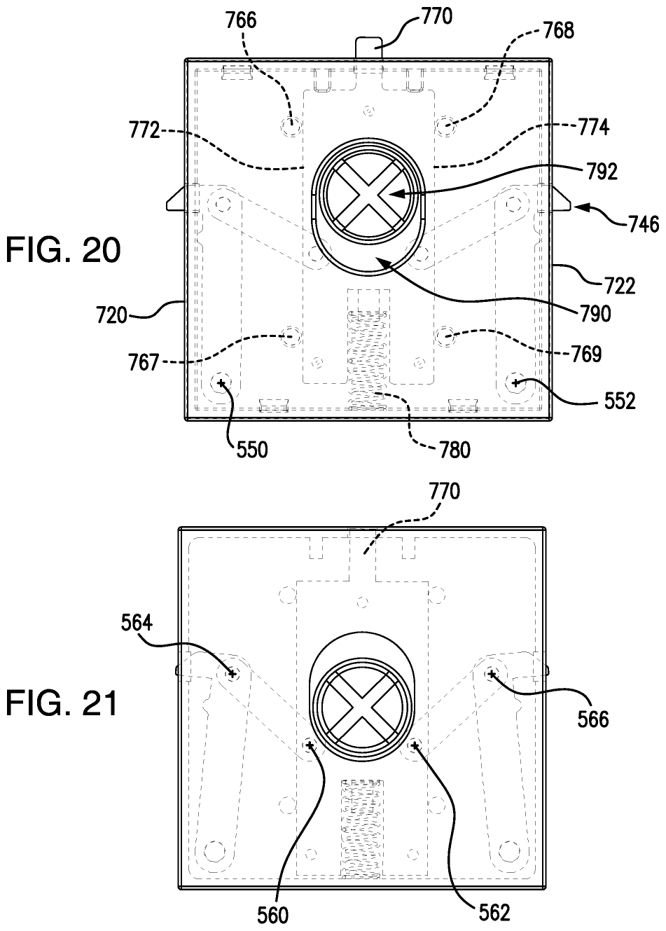

The clip further comprises respective first and second pawl members 740, 742. Each pawl member extends from a proximal end 744 to a distal end 746. The proximal ends are mounted for rotation about an axis 550, 552 (FIG. 20). Exemplary axes 550, 552 are formed by pivot pins 750, 752 (FIG. 19) formed as a portion of the cover 728 (e.g., as a unitary plastic molding or aluminum alloy machining).

The pawl members have respective extended (FIG. 20) and retracted (FIG. 21) conditions. In the extended condition (FIG. 20), the distal portion 746 protrudes beyond the associated side 720 or 722. The exemplary sides are formed by the sidewall 732 of the cover and have associated openings 748 (FIG. 19) for passing the respective distal portions 746.

The pawl members also have a retracted condition (FIG. 21) with the distal portions 746 relatively retracted within the body relative to the extended condition. Movement between the retracted and extended conditions is via pivoting about the respective axis 550, 552. To actuate the movement between retracted and extended conditions, an actuator member 760 (FIG. 18) may be coupled to the pawl members 740, 742. The exemplary actuator member 760 is coupled to the pawl members by respective links 762, 764. The exemplary links have a first pivot axis 560, 562 (FIG. 21) relative to the actuator member and a second pivot axis 564, 566 relative to the associated pawl (e.g., relatively toward the distal portion).

The actuator member 760 is formed as a slide, mounted for reciprocal movement between an upper position (FIG. 20) associated with the pawl extended condition and a lower position (FIG. 21) associated with the pawl retracted condition. For such mounting, the exemplary actuator member is formed as a slide having lateral sides 772, 774 in sliding engagement with pins 766 and 767 on the one hand and 768, 769 on the other hand. The exemplary actuator member has a central upper protruding portion (protrusion or tab) 770. In the upper position, the portion 770 protrudes above the upper edge or side of the body 702 formed by the sidewall 732. FIG. 19 shows an aperture 778 in the upper leg of the sidewall for passing the portion 770.

FIG. 20 further shows a spring 780 (e.g., a coil compression spring) biasing the actuator member 760 from the lower position to the upper position and thus, via the links 762, 764, biasing the pawls from their retracted condition toward their extended condition. The exemplary spring 780 is held in compression between the actuator member and an inboard surface of the sidewall along the bottom of the cover. In the exemplary embodiment, a slot is formed in the slide member extending upward from a lower end and having, at its top, a downwardly protruding pin portion captured in an upper portion of the spring to laterally hold the spring in place. FIG. 20 further shows a vertically elongate aperture 790 in the cover member plate portion 730. The aperture 790 exposes or passes a portion of the actuator member 760 allowing the actuator member to be manually engaged by a user's finger. In the exemplary implementation, the actuator includes a button portion 792 protruding into the aperture but being flush to the outboard surface. The exemplary button has a central concavity allowing easy gripping. Thus, a user may apply his or her finger to the button and draw the slide downward compressing the spring and retracting the pawls. This also retracts the protrusion 770.

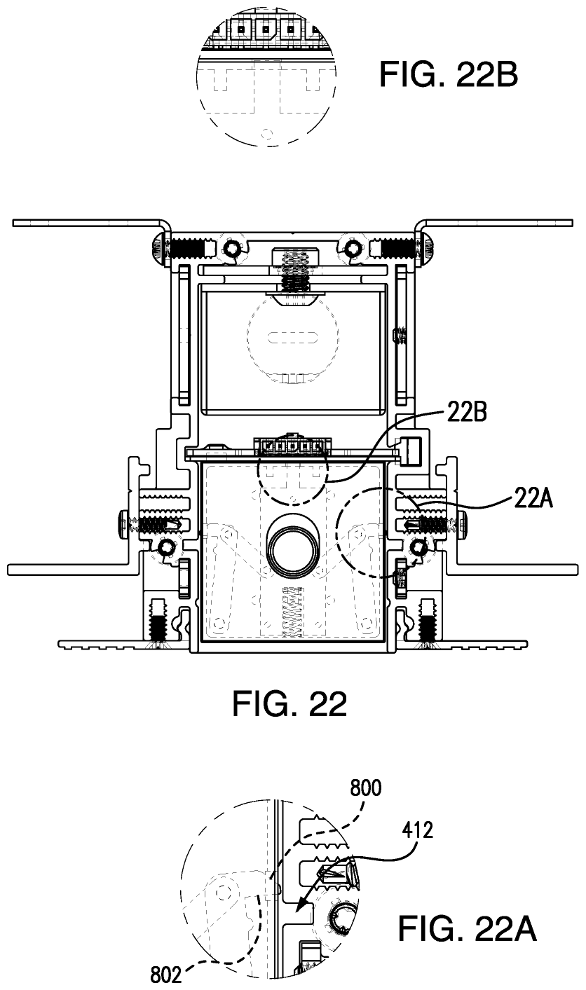

FIG. 22 shows the fixture body with seismic clips fully installed into the track extrusion 22. The pawls are at or near their retracted condition and the upper surface of the base is firmly engaged to the underside of the board 56. This insertion may be achieved by the user using his or her fingers to hold the actuator member 760 in its lower position. Or, in the exemplary embodiment, upper surfaces 800 (FIG. 22A) of the distal portions 746 may be angled to provide a camming action so that with the distal portions extended contact with portions of the track extrusion during installation produce a camming action driving the pawls inward toward their retracted conditions. To provide further assistance in retraction, the protrusions 770 will depress as the base approaches the underside of the board 56 (e.g., the underside(s) 118 of the PCB(s)). As is seen in FIG. 22, the pawls pass adjacent the channels 410, 412 as the base approaches the board. As one further raises the base, the protrusion 770 contacts the board underside and helps drive the pawls out of the channels 410, 412. Thus, a user may not have to hold the buttons 792 when installing the base.

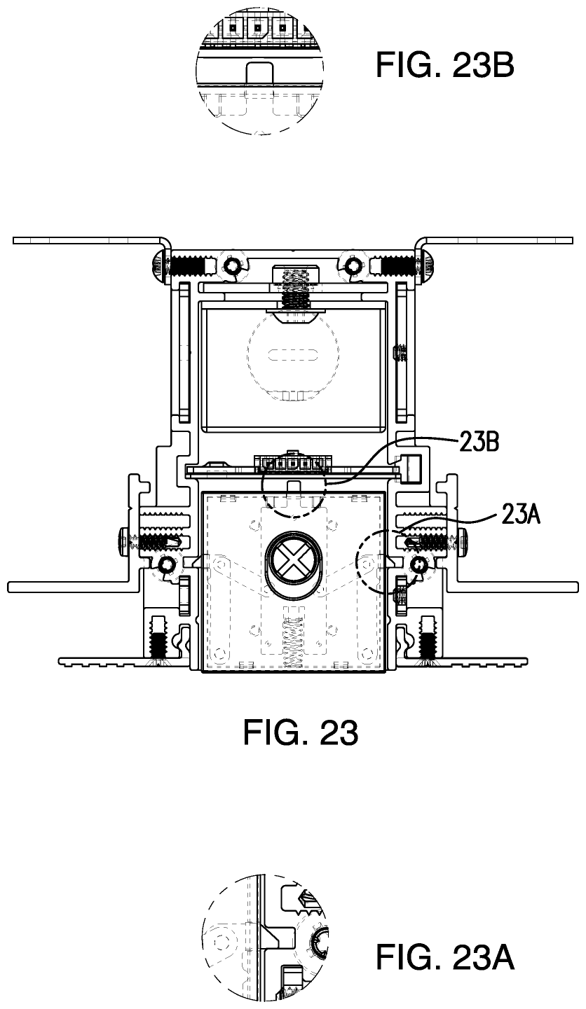

However, if a vibration is sufficient to shake the magnetic mounting of the base loose, as the base falls away from the PCB, the spring bias will drive the pawl distal portions outward and into the channels 410, 412. The undersides 802 of the pawl distal portions are not angled to allow a camming release. Thus, the undersides of the pawl distal portions will firmly seat against the lower sidewalls of the channels 410, 412 (FIG. 23) and prevent any further disengagement of the base from the channel 22. After such a loosening, a user may simply press the base back up into its seated magnetically mounted condition. Or the user may apply his or her fingers to the buttons 792, retract the pawl distal portions, and remove the base.

In one example, the magnets are strong enough so that they will be able to pull the base from the FIG. 23 condition to the FIG. 22 condition. Thus, although a seismic event may produce enough force to shift the base from the FIG. 22 condition to the FIG. 23, upon termination of that force, the magnetic force will re-seat the base. A similar dynamic may occur from non-seismic forces such as a person pulling on of otherwise disturbing the fixture (without first actuating the release buttons 792.

In one example, all of the clip components other than the spring are injection molded plastics (e.g., ABS and/or polycarbonate). Base plate 724 and cover member 726 may snap together or be heat welded or adhesive bonded (e.g., epoxy). The springs may be stainless or other spring steel wire coil springs. Mounting of the clips to the ends of the base may be via adhesive (e.g. epoxy). One or more locating features (not shown) may be added such as tabs or snaps or screw holes.

The use of “first”, “second”, and the like in the description and following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

Where a measure is given in English units followed by a parenthetical containing SI or other units, the parenthetical's units are a conversion and should not imply a degree of precision not found in the English units.

One or more embodiments have been described. Nevertheless, it will be understood that various modifications may be made. For example, when applied to an existing basic system, details of such configuration or its associated use may influence details of particular implementations. Accordingly, other embodiments are within the scope of the following claims.

1. A system comprising:
a body having a first sidewall and a second sidewall, a first channel formed in an inner surface of the first sidewall and a second channel formed in an inner surface of the second sidewall;
one or more members positioned with a first edge portion in the first channel and a second edge portion in the second channel; and
one or more biasing members in the second channel engaging the one or more members and biasing the one or more members into the first channel.

2. The system of claim 1 wherein:
the one or more biasing members comprise one or more wave springs.

3. The system of claim 1 wherein:
the one or more biasing members comprise one or more metallic springs.

4. The system of claim 1 wherein:
the one or more members have, adjacent the first edge portion, a recess or through-hole in a lower surface.

5. The system of claim 1 wherein:
the one or more members comprise one or more board assemblies.

6. The system of claim 5 wherein:
the one or more board assemblies each comprise a plurality of electrical contacts running longitudinally along a lower surface of the board assembly.

7. The system of claim 5 wherein:
the one or more board assemblies each comprise a steel portion.

8. The system of claim 7 wherein:
the steel portion is a substrate extending along at least 90% of a footprint of the member.

9. The system of claim 8 wherein:
the substrate has, adjacent the first edge portion, a plurality of protrusions along an upper surface.

10. The system of claim 7 wherein:
the one or more board assemblies each comprise a first connector at a first end and a second connector at a second end.

11. The system of claim 10 wherein:
the one or more board assemblies are a plurality of board assemblies electrically connected via one or more pairs of adjacent said first connectors and said second connectors.

12. The system of claim 7 further comprising:
one or more accessories having at least one magnet magnetically mounting the accessory to the one or more members via magnetic interaction with the steel portion.

13. The system of claim 12 wherein:
the one or more board assemblies each comprise a plurality of electrical contacts running longitudinally along a lower surface of the board assembly; and
the one or more accessories have electrical contacts contacting the one or more electrical contacts of the one or more board assemblies.

14. The system of claim 1 wherein:
the body comprises an extrusion.

15. The system of claim 1 wherein:
the body comprises a plurality of aluminum alloy extrusions mounted end-to-end.

16. A method for assembling the system of claim 1, the method comprising:
with the one or more biasing members in the second channel, shifting the one or more members so that their respective second edge portions align with an opening of the second channel;
shifting the one or more members to shift their respective second end portions into the second channel while rotating the one or more members to align their first edge portions with the first channel and compressing the one or more biasing members; and
shifting the one or more members to seat their first edge portions into the first channel while leaving their second edge portions in the second channel.

17. The method of claim 16 further comprising:
inserting a base of an accessory into the body between the first sidewall and the second sidewall so as to engage the one or more members electrically and magnetically, the magnetic engagement effective to retain the accessory to the body.

18. The method of claim 16 further comprises:
assembling the body from a plurality of body segments, the body segments being assembled end-to-end with inter-linking members captured by adjacent sections.

19. A seismic clip for retaining a fixture to a track channel, the track channel having a pair of opposed sidewalls, each having an inwardly-open channel, the seismic clip comprising:
a body having a first face and a second face and first and second opposite sides;
first and second members movable between a retracted condition and an extended condition protruding from the first and second sides respectively; and
a spring, biasing the first and second members from the retracted condition toward the extended condition.

20. The seismic clip of claim 19 further comprising:
a release member having a portion exposed or protruding through the second face.

21. The seismic clip of claim 20 wherein:
the release member is mounted for reciprocal movement;
the first and second members are mounted for pivotal movement relative to the body about respective pivot axes; and
respective first and second links couple the first and second members to the release member and each have a respective proximal pivot relative to the release member and a respective distal pivot respectively relative to the first member and the second member.

22. (canceled)

23. (canceled)

24. The seismic clip of claim 20 wherein the release member has a portion having:
a first condition protruding from a proximal edge of the body with the first and second members retracted; and
a second condition retracted relative to the first condition with the first and second members extended.

25. A fixture having a base and a pair of seismic clips of claim 19, wherein:
the base has a first end and a second end;
a first seismic clip of said pair is at the first end; and
a second seismic clip of said pair is at the second end.
